(19) United States
(12) Patent Application Publication
(10) Pub. No.: US 2013/0239079 A1
(43) Pub. Date: Sep. 12, 2013

(54) SYSTEM AND METHOD FOR TAKING INTER-CLOCK CORRELATION INTO ACCOUNT IN ON-CHIP TIMING DERATING

(71) Applicant: Alexander Tetelbaum, Walnut Creek, CA (US)

(72) Inventor: Alexander Tetelbaum, Walnut Creek, CA (US)

(21) Appl. No.: 13/416,609

(22) Filed: Mar. 9, 2012

(51) Int. Cl. G06F 17/50

(52) U.S. Cl. 716/113

(57) ABSTRACT

One aspect provides a system for taking inter-clock correlation into account in on-chip timing derating. The system comprises a storage medium and an electronic design automation tool. The storage medium is configured to store data and clock path setup and hold early and late derate data. The electronic design automation tool is configured to employ at least some of said data and clock path setup and hold early and late derate data to calculate setup and hold slacks and total derate that take into account a correlation in delay variation between first and second clock paths as a function of depths thereof.

### TECHNICAL FIELD

This application is directed, in general, to integrated circuit (IC) design and, more specifically, to a timing signoff system and method that takes static and dynamic voltage drop into account.

### BACKGROUND

Circuit designers use electronic design automation (EDA) tools, a category of computer aided design (CAD) tools, to design and lay out electronic circuits, including simulating the operation of the circuit, determining where cells (i.e., logic elements including devices, e.g., transistors) should be placed and where the interconnects that couple the cells together should be routed. EDA tools allow designers to construct a circuit and simulate its performance using a computer and without requiring the costly and lengthy process of fabrication. EDA tools are indispensable for designing modern ICs, particularly very-large-scale integrated circuits (VSLICs). For this reason, EDA tools are in wide use.

One such EDA tool performs timing signoff. Timing signoff is one of the last steps in the IC design process and ensures that signal propagation speed (i.e., delay) in a newly-designed circuit is such that the circuit will operate as intended. Signals that propagate too slowly through the circuit cause setup violations; signals that propagate too quickly through the circuit cause hold violations. Setup or hold violations frustrate the logic of the circuit and prevent it from performing the job it was designed to do.

Timing signoff is performed with highly accurate models of the circuit under multiple sets of assumptions regarding expected variations, called “corners.” Process-voltage-temperature (PVT) corners are based on assumptions regarding variations in device operation from one IC to another, supply voltage and operating temperature. Resistance-capacitance (R, C, or RC) corners are based on assumptions regarding variations in one or both of interconnect resistance and capacitance from one IC to another. Conventional timing signoff identifies setup and hold violations in a “slow” PVT corner (in which process variations are assumed to yield relatively slow-switching devices and supply voltage and operating temperature are such that device switching speed are their slowest) and a “worst” RC corner (in which process variations are assumed to yield interconnects having relatively high resistance and capacitance). Conventional timing signoff also identifies hold violations in a “fast” PVT corner (in which process variations are assumed to yield relatively fast-switching devices and supply voltage and operating temperature are such that device switching speeds are their fastest) and a “best” RC corner (in which process variations are assumed to yield interconnects having relatively low resistance and capacitance). Conventional signoff timing also takes on-chip variations (OCV), which are process variations occurring over the area of a given IC, into account using statistical methods. Timing derating factors may be employed during STA to model the effects of process variations. The derating factors, which are usually expressed in terms of a percentage, specify the degree to which all or specific cells, nets or both in a given IC design should be sped up or slowed down.

### SUMMARY

One aspect provides a system for taking inter-clock correlation into account in on-chip timing derating. In one embodiment, the system includes: (1) a storage medium configured to store data and clock path setup and hold early and late derate data and (2) an electronic design automation tool configured to employ at least some of the data and clock path setup and hold early and late derate data to calculate setup and hold slacks and total derate that take into account a correlation in delay variation between first and second clock paths as a function of depths thereof.

Another aspect provides a method of for taking inter-clock correlation into account in on-chip timing derating. In one embodiment, the method includes: (1) configuring a storage medium to store data and clock path setup and hold early and late derate data and (2) employing at least some of the data and clock path setup and hold early and late derate data to calculate setup and hold slacks and total derate that take into account a correlation in delay variation between first and second clock paths as a function of depths thereof.

Yet another aspect provides a computer-readable storage medium containing program instructions for taking inter-clock correlation into account in on-chip timing derating. In one embodiment, execution of the program instructions by one or more processors of a computer system causes the one or more processors to: (1) configure a storage medium to store data and clock path setup and hold early and late derate data and (2) employ at least some of the data and clock path setup and hold early and late derate data to calculate setup and hold slacks and total derate that take into account a correlation in delay variation between first and second clock paths as a function of depths thereof.

### BRIEF DESCRIPTION

Reference is now made to the following descriptions taken in conjunction with the accompanying drawings, in which:

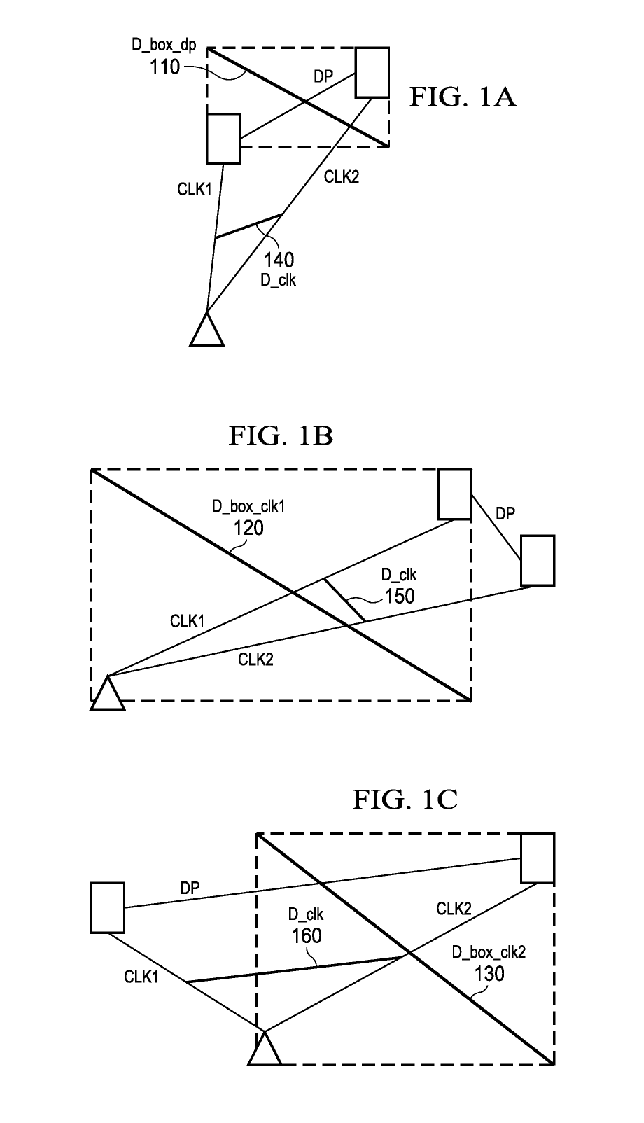

FIGS. 1A-1C are a graphical representations of path distance for three examples involving a data path and two clock paths;

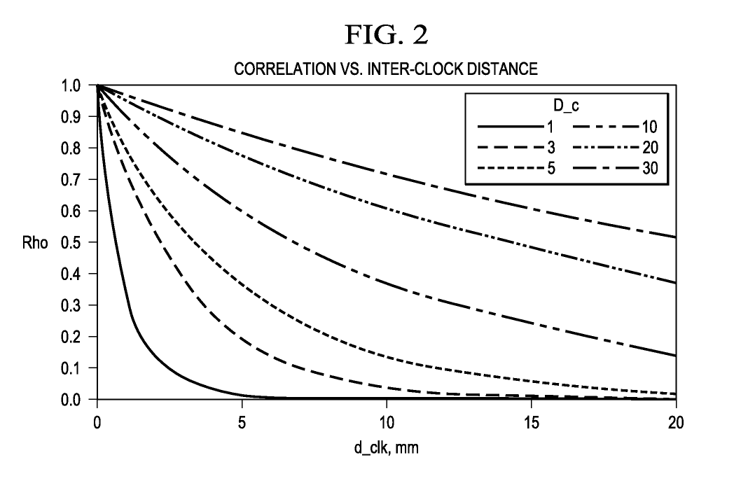

FIG. 2 is a graph representing correlation behavior as a function of inter-clock distance and a distance constant;

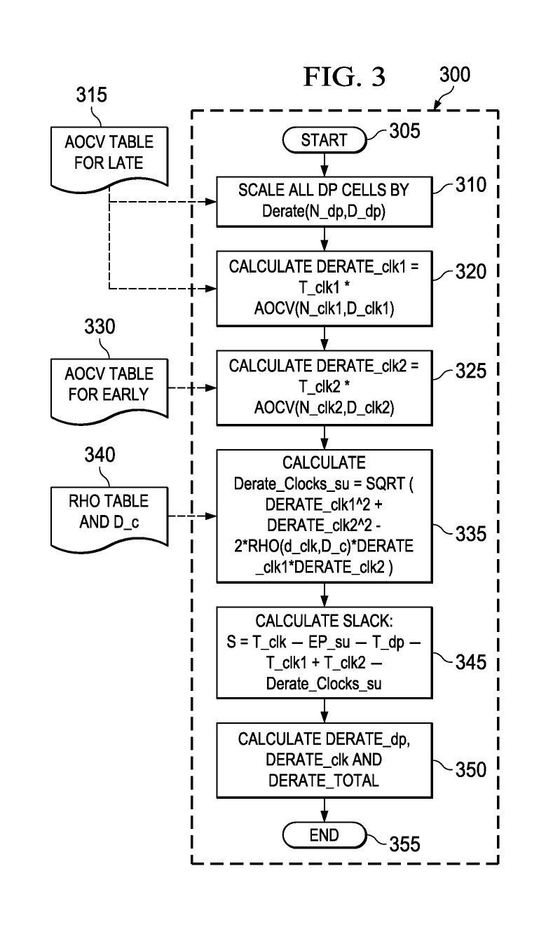

FIG. 3 is a hybrid block and flow diagram of a first embodiment of a method of taking inter-clock correlation into account in calculating setup slack;

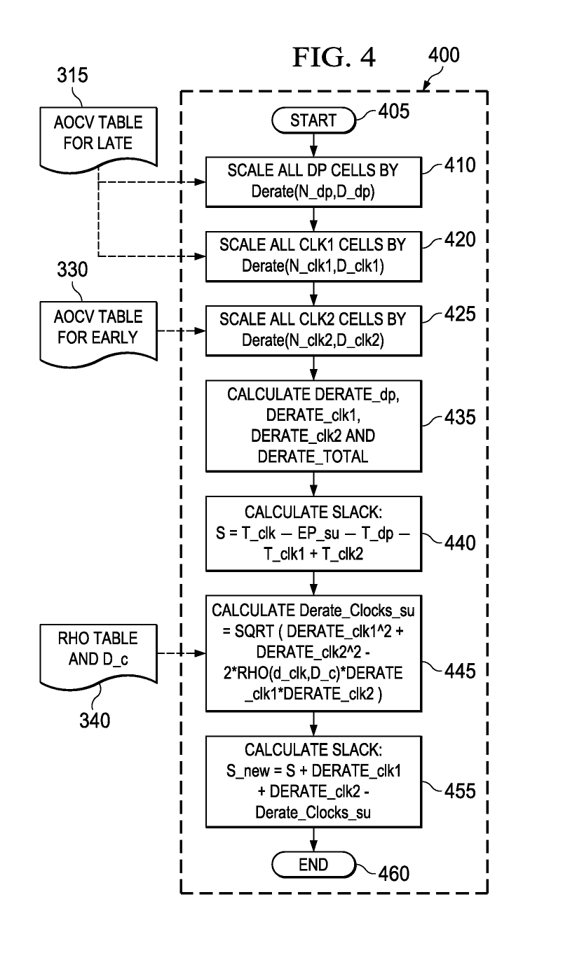

FIG. 4 is a hybrid block and flow diagram of a second embodiment of a method of taking inter-clock correlation into account in calculating setup slack;

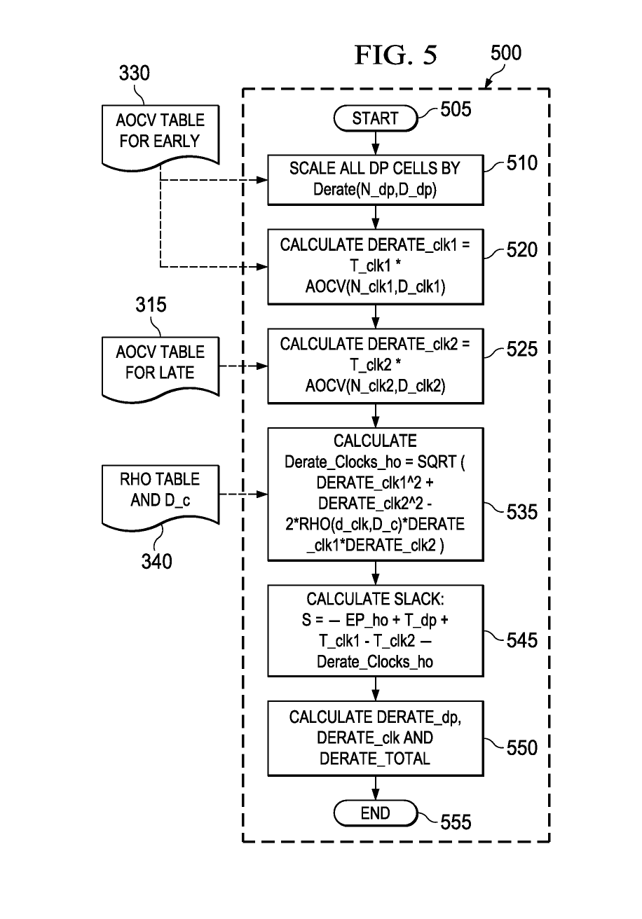

FIG. 5 is a hybrid block and flow diagram of a first embodiment of a method of taking inter-clock correlation into account in calculating hold slack;

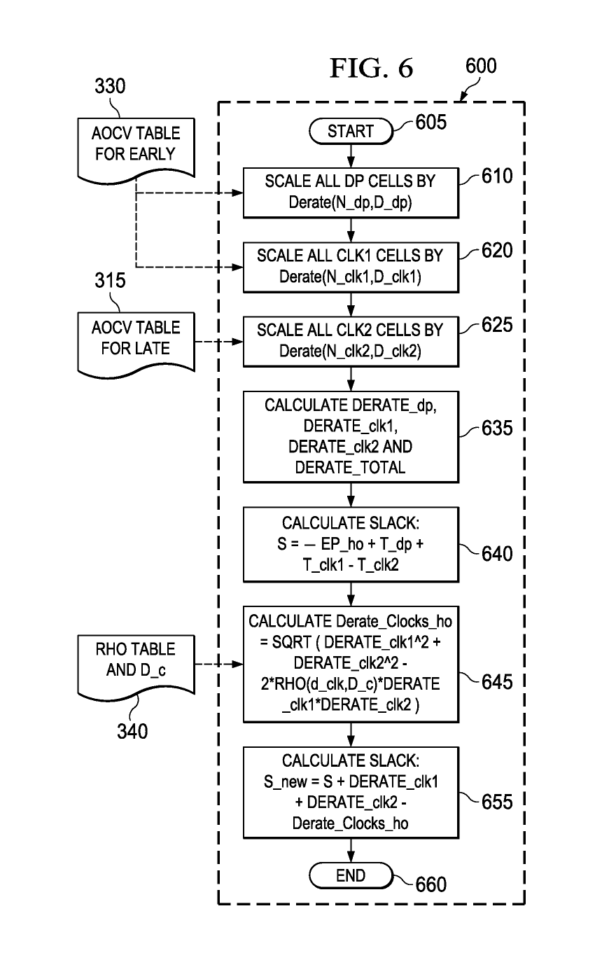

FIG. 6 is a hybrid block and flow diagram of a second embodiment of a method of taking inter-clock correlation into account in calculating hold slack;

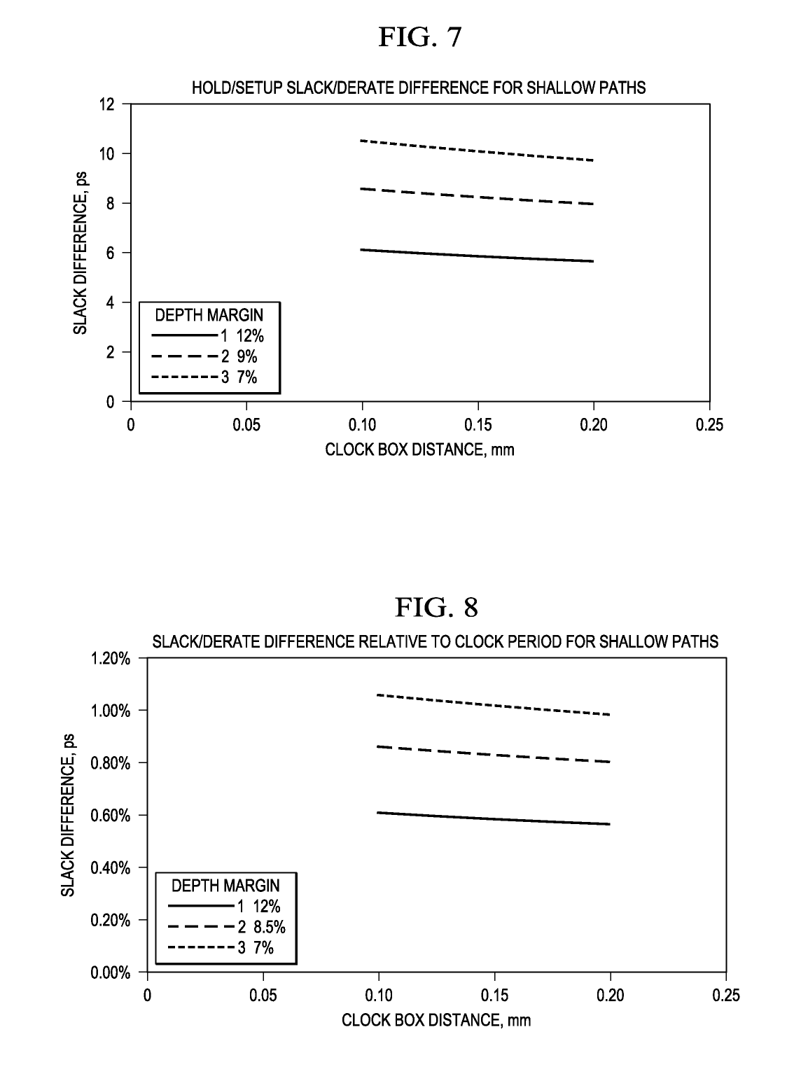

FIG. 7 is a graph showing hold and setup slack and total timing derating reduction for an example clock path having a depth of between one and three cells;

FIG. 8 is a graph showing hold and setup slack and total timing derating reduction relative to clock period for an example clock path having a depth of between one and three cells;

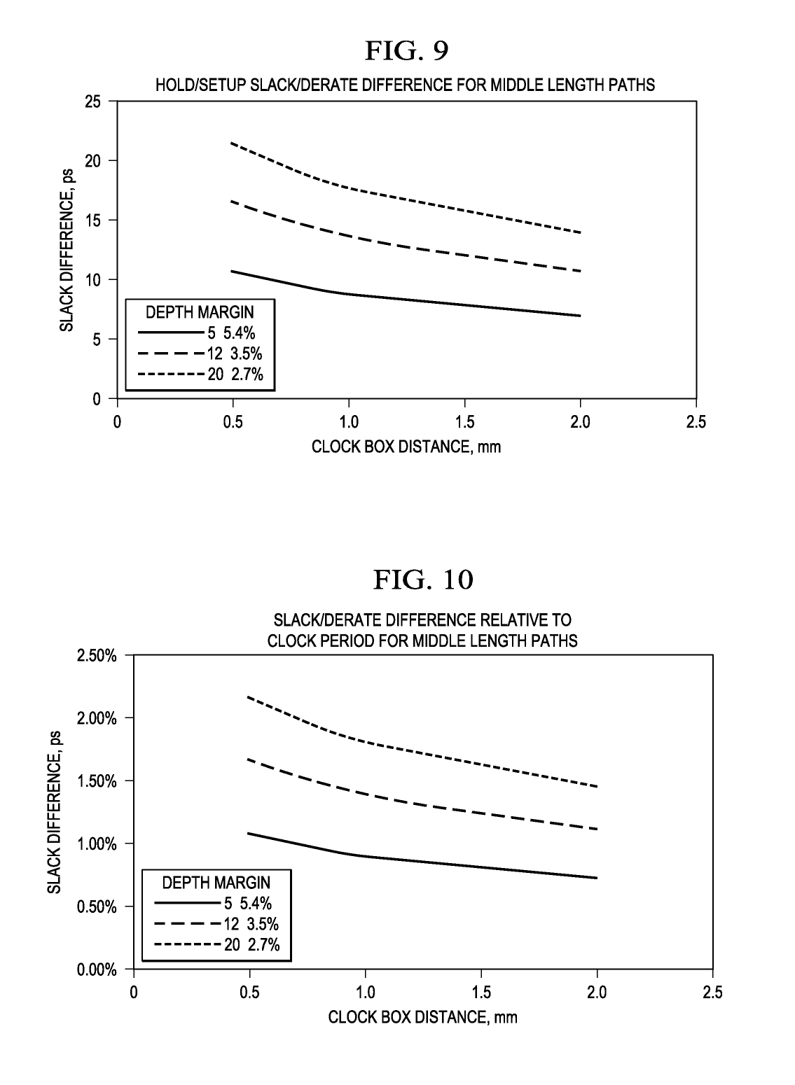

FIG. 9 is a graph showing hold and setup slack and total timing derating reduction for an example clock path having a depth of between five and 20 cells;

FIG. 10 is a graph showing hold and setup slack and total timing derating reduction relative to clock period for an example clock path having a depth of between five and 20 cells;

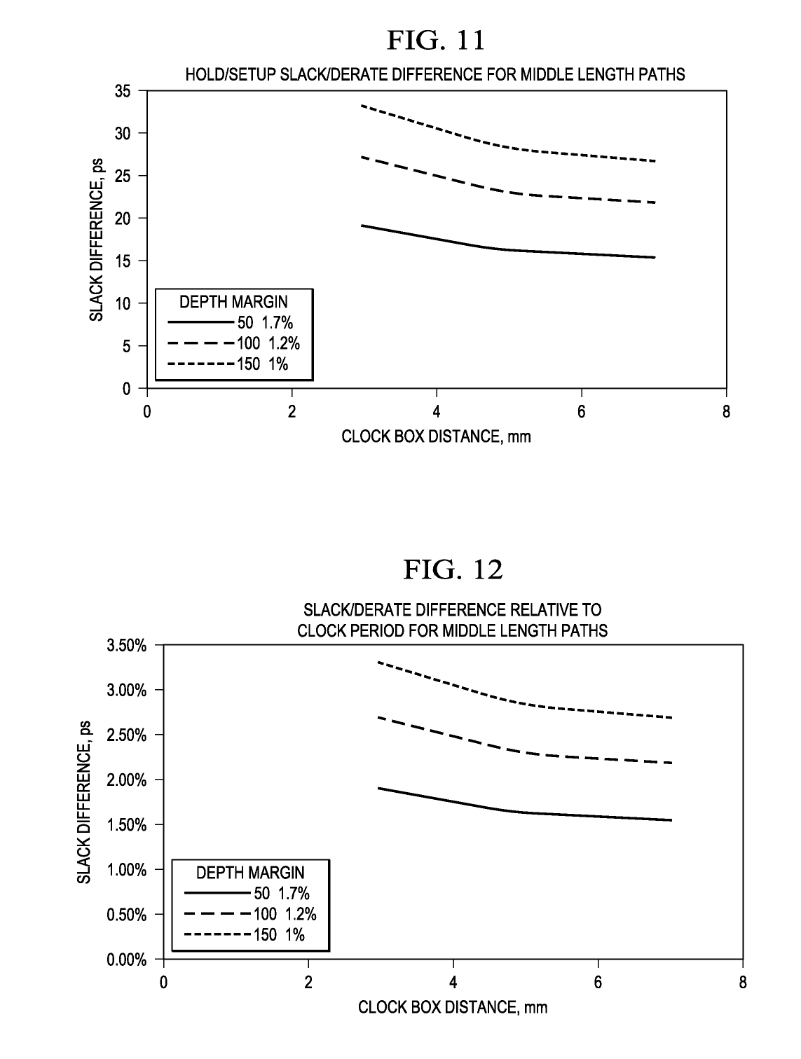

FIG. 11 is a graph showing hold and setup slack and total timing derating reduction for an example clock path having a depth of between 50 and 150 cells; and

FIG. 12 is a graph showing hold and setup slack and total timing derating reduction relative to clock period for an example clock path having a depth of between 50 and 150 cells.

### DETAILED DESCRIPTION

Described herein are various embodiments of a system and method for reducing the total timing derating that is to be applied to data or clock paths that take into account correlations between launch and capture clocks paths. Some embodiments of the system and method allow the total timing derating to be reduced to a minimum. Other embodiments reduce the timing derating that is to be applied to both data and clock paths.

A relatively sophisticated but conventional process for determining timing derating and performing STA timing signoff is known as “Advanced OCV,” or AOCV, commercially available as part of the PrimeTime® system from Synopsys of Mountain View, Calif. AOCV assigns cell and net deratings as a function of a (logical) path depth N and a (physical) distance D of cells.

Assuming a data path DP extends between a launch cell driven by a launch clock path CLK1, and a capture cell driven by a capture clock path CLK2, FIGS. 1A-1C respectively geometrically illustrate the manner in which conventional AOCV defines the distance D for DP, CLK1 and CLK2 (D_dp, D_clk1 and D_clk2). A broken-line “D_box” (i.e., D_box_dp of FIG. 1A, D_box_clk1 of FIG. 1B, and D_box_clk2 of FIG. 1C) is a bounding box surrounding a given data or clock path that represents the maximum distance between two cells in the path. The D_boxes do not represent inter-clock distance.

In FIG. 1A, D=D_dp=D_box_dp; in FIG. 1B, D=D_clk1=D_box_clk1; and in FIG. 1C, D=D_clk2=D_box_clk2. FIGS. 1A-1C therefore show D_dp as a line 110, D_clk1 as a line 120, and D_clk2 as a line 130. Conventional AOCV also defines the following variables: N_dp is the depth of DP, N_clk1 is the depth of CLK1, N_clk2 is the depth of CLK2, T_clk is the clock period, T_dp is the delay of DP, T_clk1 is the delay of CLK1, T_clk2 is the delay of CLK2, EP_su is the required end-point (EP) absolute margin for setup slack, and EP_ho is the required EP absolute margin for hold slack.

According to conventional AOCV, Derate(N,D) is defined as the derate value for a path having a depth N and a distance D. Conventional AOCV obtains Derate (N,D) from derate tables for data and clock paths provided by the user. The user-provided derate tables contain columns and rows of derate values that represent possible setup and hold late signal arrivals (derate values that are more than one) and setup and hold early signal arrivals (derate values that are less than one). In each table, the columns correspond to depth N, and rows correspond to distance D. The timing derating for any path with a total delay T_path can be calculated as T_path*Derate(N_path,D_path).

Conventional AOCV calculates setup slack as follows:

S=Slack_current_{—}su=T_clk−EP_{—}su−T_{—}dp[with AOCV_{—}su_{—}dp_late derating]−T_clk_{—}1[with AOCV_{—}su_clk_late derating]+T_clk_{—}2[with AOCV_{—}su_clk_early derating],

where AOCV_su_dp_late employs N_dp and D_dp taken from the data path setup late derate table, AOCV_su_clk_late employs N_clk and D_clk taken from the clock path setup late derate table, and AOCV_su_clk_early employs N_clk and D_clk taken from the clock path setup early derate table. Consequently, T_dp and T_clk1 are increased, and T_clk2 is decreased, as a result of conventional AOCV derating.

Conventional AOCV calculates hold slack as follows:

S=Slack_current_{—}ho=−EP_{—}ho+T_{—}dp[with AOCV_{—}ho_{—}dp_early derating]+T_clk_{—}1[with AOCV_{—}ho_clk_early derating]−T_clk_{—}2[with AOCV_{—}ho_clk_late derating],

where AOCV_ho_dp_early employs N_dp and D_dp taken from the data path hold early derate table, AOCV_ho_clk_early employs N_clk and D_clk taken from the clock path hold early derate table, and AOCV_ho_clk_late employs N_clk and D_clk taken from the clock path hold late derate table. Consequently, T_dp and T_clk1 are decreased, and T_clk2 is increased, as a result of conventional AOCV derating.

Conventional AOCV derating, as the timing derating performed by other conventional EDA tools, take into account many sources of variation, including process, voltage, temperature and inaccuracies or errors introduced by the EDA tool itself. The OCV margins resulting from this timing derating not only make the task of closing timing more difficult, they ultimately reduce system performance and design cost and time. What is needed is a way to reduce the OCV margins without compromising their essential function of protecting ICs against malfunctions arising from variations occurring during their manufacture or operation. It is realized herein that factoring inter-clock correlation into the computation of OCV margins can do this.

Neither conventional AOCV nor processes embodied in other conventional EDA tools provide a way to take inter-clock variation into account in on-chip timing derating. No way currently exists by which the user can describe to such processes the correlation in delay variation between launch and capture clock paths as a function of their depth N. These are significant shortcomings in the prior art.

It is realized herein that the impact multiple clock path delay variations have on timing slack decreases as the correlation between those variations increases, because clock variations at least partially cancel each other in the slack. In fact, it is realized herein the clock variations cancel each other fully (i.e., RHO=1) and have no impact on slack whatsoever as the clock path distance D approaches zero.

Various embodiments of the system and method described herein provide a mechanism by which the correlation in delay variation between first and second clock paths as a function of their depth N (defined herein as “RHO”) can be provided to a timing derating process. Various embodiments of the system and method also introduce not only a novel way to calculate setup and hold slacks and total derate that take RHO into account, but also a way to adapt the conventional AOCV process such that they can take RHO into account. In some embodiments, the first clock path CLK1 is a launch clock path for a given data path, and the second clock path CLK2 is a capture clock path for the given data path.

First embodiments of the system and method described herein operate to a greater extent within the context of a conventional AOCV process than do second embodiments described herein. According to the first embodiments, conventional AOCV derate values are initially applied to calculate slack. Then slack is re-calculated according to the teachings herein.

The first embodiments of the system and method calculate setup slack as follows:

S=T_clk−EP_{—}su−T_{—}dp[with AOCV_{—}su_{—}dp_late derating]−T_clk_{—}1[without AOCV derating]+T_clk_{—}2[without AOCV derating]−Derate_Clocks_{—}su,

where AOCV_su_dp_late employs N_dp and D_dp taken from the data path setup late derate table.

The first embodiments of the system and method calculate setup derate as follows:

Derate_Clocks_{—}su=SQRT(V_clk1_{—}pŝ2+V_clk2_{—}pŝ2−2*RHO(d_clk)*V_clk1_{—}ps*V_clk2_{—}ps),

where:

V_clk1_{—}ps=DERATE_clk1=T_clk1*AOCV_{—}su_clk_late(N_clk1,D_clk1), and

V_clk2_{—}ps=DERATE_clk2=T_clk2*AOCV_{—}su_clk_early(N_clk2,D_clk2),

where RHO(d_clk) is taken from a table of RHO values given as function of the distance d_clk between clock paths.

The first embodiments of the system and method calculate hold slack as follows:

S=−EP_{—}ho+T_{—}dp*[w/ AOCV_{—}ho_{—}dp_early derating]+T_{—}clk_{—}1[w/o AOCV derating]−T_{—}clk_{—}2[w/o AOCV derating]−Derate_Clocks_{—}ho,

where AOCV_ho_dp_early employs N_dp and D_dp taken from the data path hold early derate table

The first embodiments of the system and method calculate hold derate as follows:

Derate_Clocks_{—}ho=SQRT(V_clk1_{—}pŝ2+V_clk2_{—}pŝ2−2*RHO(d_clk)*V_clk1_{—}ps*V_clk2_{—}ps),

where:

V_clk1_{—}ps=DERATE_clk1=T_clk1*AOCV_{—}ho_clk_early(N_clk1,D_clk1), and

V_clk2_{—}ps=DERATE_clk2=T_clk2*AOCV_{—}ho_clk_late(N_clk2,D_clk2).

The first embodiments of the system and method then re-calculate setup and hold slack respectively as follows:

Slack_{—}su_new=Slack_{—}su_current+DERATE_{—}su_clk1+DERATE_{—}su_clk2−Derate_Clocks_{—}su, and

Slack_{—}ho_new=Slack_{—}ho_current+DERATE_{—}ho_clk1+DERATE_{—}ho_clk2−Derate_Clocks_{—}ho.

The second embodiments of the system and method calculate slack and derate without reference to conventional slack calculations. They do not involve re-calculation and therefore may be regarded as computationally more efficient. Hybrid block and flow diagrams directed to both the first and second embodiments will de described below in conjunction with FIGS. 3-6. However, some concepts will be described further before turning to those embodiments.

Returning to FIGS. 1A-1C, illustrated are lines 140, 150, 160 respectively graphically representing one embodiment of the inter-clock distance d_clk as introduced herein for the data path DP and the clock paths CLK1, CLK2. As is apparent, the lines 140, 150, 160 extend between the centerpoints of the clock paths CLK1 and CLK2 (which would be the centers of their bounding boxes). The inter-clock distance d_clk is equivalently the average distance between the cells in CLK1 and CLK2.

FIG. 2 is a graph representing correlation behavior as a function of the inter-clock distance d_clk and a distance constant D_c that may be employed in some embodiments to scale d_clk. The value of D_c depends on the source of variation (e.g., process, voltage or temperature). It is apparent from an examination of FIG. 2 that the smaller the inter-clock distance d_clk, the higher the inter-clock correlation RHO. RHO may be expressed as a graph (e.g., per FIG. 2). However, for ease of use in the context of timing analysis, Rho may better be expressed as a table. Table 1, below, sets forth example RHO values:

TABLE 1
Inter-Clock Correlation RHO Between Clock Paths as
a Function of d_clk (mm) and D_c (mm)

| | 0.1 | 0.2 | 0.5 | 1 | 2 | 5 | 10 | 20 |
|---|---|---|---|---|---|---|---|---|
| 1 | 0.9048 | 0.8187 | 0.6065 | 0.3679 | 0.1353 | 0.0067 | 0.0000 | 0.0000 |
| 3 | 0.9672 | 0.9355 | 0.8465 | 0.7165 | 0.5134 | 0.1889 | 0.0357 | 0.0013 |
| 5 | 0.9802 | 0.9608 | 0.9048 | 0.8187 | 0.6703 | 0.3679 | 0.1353 | 0.0183 |
| 10 | 0.9900 | 0.9802 | 0.9512 | 0.9048 | 0.8187 | 0.6065 | 0.3679 | 0.1353 |
| 20 | 0.9950 | 0.9900 | 0.9753 | 0.9512 | 0.9048 | 0.7788 | 0.6065 | 0.3679 |
| 30 | 0.9967 | 0.9934 | 0.9835 | 0.9672 | 0.9355 | 0.8465 | 0.7165 | 0.5134 |

Those skilled in the pertinent art will recognize, however, that any data structure may be appropriate for conveying RHO.

FIG. 3 is a hybrid block and flow diagram of a first embodiment of a method of taking inter-clock correlation into account in calculating setup slack. The system includes an EDA tool 300. To perform timing signoff with respect to an IC design, the illustrated embodiment of the EDA tool 300 is configured to extract data regarding the design from various sources, which may take the form of tables configured to contain derate, correlation and distance constant data.

The method begins in a start step 305. In a step 310, all cells in a particular data path DP are derated by Derate(N_dp,D_dp). The step 310 is performed with reference to derate data contained in data and clock path setup and hold late derate tables 315 stored in a conventional or later-developed storage medium.

In a step 320, the derate that should be applied to a first clock path CLK1 (i.e., DERATE_clk1) is, in the illustrated embodiment, calculated as DERATE_clk1=T_clk1*AOCV(N_clk1,D_clk1). The step 320 is performed with reference to the data contained in the data and clock path setup and hold late derate tables 315. In one embodiment, CLK1 is the path of a launch clock for DP.

In a step 325, the derate that should be applied to a second clock path CLK2 (i.e., DERATE_clk2) is, in the illustrated embodiment, calculated as DERATE_clk2=T_clk2*AOCV(N_clk2,D_clk2). The step 325 is performed with reference to derate data contained in a data and clock path setup and hold early derate tables 330 stored in a conventional or later-developed storage medium. In one embodiment, CLK1 is the path of a capture clock for DP.

In a step 335, setup derate (taking into account the correlation that exists between CLK1 and CLK2) is calculated. Derate_Clocks_su is, in the illustrated embodiment, calculated as follows: Derate_Clocks_su=SQRT(DERATE_clk1̂2+DERATE_clk2̂2−2*RHO(d_clk,D_c)*DERATE_clk1*DERATE_clk2). The step 320 is performed with reference to correlation (RHO) and distance constant (D_c) data contained in correlation and distance constant tables 340 stored in a conventional or later-developed storage medium.

In a step 345, setup slack is, in the illustrated embodiment, calculated as follows: S=T_clk−EP_su−T_dp−T_clk1+T_clk2−Derate_Clocks_su. In a step 350, the derate for the data path DP (i.e., DERATE_dp), the derate for the clock paths CLK1 and CLK2 (i.e., DERATE_clk) and the total derate (i.e., DERATE_TOTAL) are calculated. The method ends in an end step 355.

FIG. 4 is a hybrid block and flow diagram of a second embodiment of a method of taking inter-clock correlation into account in calculating setup slack. The system includes an EDA tool 400. In the illustrated embodiment, the EDA tool 400 includes or is an enhanced embodiment of a conventional STA tool. To perform timing signoff with respect to an IC design, the illustrated embodiment of the EDA tool 400 is configured to extract data regarding the design from various sources, which may take the form of tables configured to contain derate, correlation and distance constant data.

The method begins in a start step 405. In a step 410, all cells in a particular data path DP are scaled (derated) by Derate(N_dp,D_dp). The step 410 is performed with reference to derate data contained in the data and clock path setup and hold late derate tables 315 described above.

In a step 420, all cells in a first clock path CLK1 are scaled (derated) by Derate(N_clk1,D_clk1). The step 420 is performed with reference to the data contained in the data and clock path setup and hold late derate tables 315.

In a step 425, all cells in a second clock path CLK2 are scaled (derated) by Derate(N_clk2,D_clk2). The step 425 is performed with reference to the data contained in the data and clock path setup and hold early derate tables 330 described above.

In a step 435, the derate for the data path DP (i.e., DERATE_dp), the derate for the clock paths CLK1 and CLK2 (i.e., DERATE_clk) and the total derate (i.e., DERATE_TOTAL) are calculated. In a step 440, setup slack is, in the illustrated embodiment, calculated as follows: S=T_clk−EP_su−T_dp−T_clk1+T_clk2.

In a step 445, the setup derate (taking into account the correlation that exists between CLK1 and CLK2) is calculated. Derate_Clocks_su is, in the illustrated embodiment, calculated as follows: Derate_Clocks_su=SQRT(DERATE_clk1̂2+DERATE_clk2̂2−2*RHO(d_clk,D_c)*DERATE_clk1*DERATE_clk2). The step 445 is performed with reference to RHO and D_c data contained in the correlation and distance constant tables 340 described above. In a step 455, slack is calculated in the illustrated embodiment as S_new=S+DERATE_clk1+DERATE_clk2−Derate_Clocks_su. The method ends in an end step 460.

FIG. 5 is a hybrid block and flow diagram of a first embodiment of a method of taking inter-clock correlation into account in calculating hold slack. The system includes an EDA tool 500. To perform timing signoff with respect to an IC design, the illustrated embodiment of the EDA tool 500 is configured to extract data regarding the design from various sources, which may take the form of tables configured to contain derate, correlation and distance constant data.

The method begins in a start step 505. In a step 510, all cells in a particular data path DP are scaled (derated) by Derate(N_dp,D_dp). The step 510 is performed with reference to derate data contained in the data and clock path setup and hold early derate tables 330 described above.

In a step 520, the derate that should be applied to a first clock path CLK1 (i.e., DERATE_clk1) is, in the illustrated embodiment, calculated as DERATE_clk1=T_clk1*AOCV(N_clk1,D_clk1). The step 520 is performed with reference to the data contained in the data and clock path setup and hold early derate tables 330.

In a step 525, the derate that should be applied to a second clock path CLK2 (i.e., DERATE_clk2) is, in the illustrated embodiment, calculated as DERATE_clk2=T_clk2*AOCV(N_clk2,D_clk2). The step 525 is performed with reference to derate data contained in the data and clock path setup and hold late derate tables 315 described above.

In a step 335, setup derate (taking into account the correlation that exists between CLK1 and CLK2) is calculated. Derate_Clocks_ho is, in the illustrated embodiment, calculated as follows: Derate_Clocks_ho=SQRT(DERATE_clk1̂2+DERATE_clk2̂2−2*RHO(d_clk,D_c)*DERATE_clk1*DERATE_clk2). The step 320 is performed with reference to RHO and D_c data contained in the correlation and distance constant tables 340 described above.

In a step 545, setup slack is, in the illustrated embodiment, calculated as follows: S=T_clk−EP_su−T_dp−T_clk1+T_clk2−Derate_Clocks_ho. In a step 550, the derate for the data path DP (i.e., DERATE_dp), the derate for the clock paths CLK1 and CLK2 (i.e., DERATE_clk) and the total derate (i.e., DERATE_TOTAL) are calculated. The method ends in an end step 555.

FIG. 6 is a hybrid block and flow diagram of a second embodiment of a method of taking inter-clock correlation into account in calculating hold slack. The system includes an EDA tool 600. In the illustrated embodiment, the EDA tool 600 includes or is an enhanced embodiment of a conventional STA tool. To perform timing signoff with respect to an IC design, the illustrated embodiment of the EDA tool 600 is configured to extract data regarding the design from various sources, which may take the form of tables configured to contain derate, correlation and distance constant data.

The method begins in a start step 605. In a step 610, all cells in a particular data path DP are scaled (derated) by Derate(N_dp,D_dp). The step 610 is performed with reference to derate data contained in the data and clock path setup and hold early derate tables 330 described above.

In a step 620, all cells in a first clock path CLK1 are scaled (derated) by Derate(N_clk1,D_clk1). The step 620 is performed with reference to the data contained in the data and clock path setup and hold early derate tables 330.

In a step 625, all cells in a second clock path CLK2 are scaled (derated) by Derate(N_clk2,D_clk2). The step 625 is performed with reference to the data contained in the data and clock path setup and hold late derate tables 315 described above.

In a step 635, the derate for the data path DP (i.e., DERATE_dp), the derate for the clock paths CLK1 and CLK2 (i.e., DERATE_clk) and the total derate (i.e., DERATE_TOTAL) are calculated. In a step 640, hold slack is, in the illustrated embodiment, calculated as follows: S=T_clk−EP_ho−T_dp−T_clk1+T_clk2.

In a step 645, the hold derate (taking into account the correlation that exists between CLK1 and CLK2) is calculated. Derate_Clocks_ho is, in the illustrated embodiment, calculated as follows: Derate_Clocks_ho=SQRT(DERATE_clk1̂2+DERATE_clk2̂2−2*RHO(d_clk,D_c)*DERATE_clk1*DERATE_clk2). The step 645 is performed with reference to RHO and D_c data contained in the correlation and distance constant tables 340 described above. In a step 655, slack is calculated in the illustrated embodiment as S_new=S+DERATE_clk1+DERATE_clk2−Derate_Clocks_ho. The method ends in an end step 460.

FIGS. 7-12 illustrate slack and total derate reduction when using embodiments of the system and method disclosed herein versus a conventional system and method. FIGS. 7 and 8 show improvement for an example (relatively short) clock path having a depth of between one and three cells. FIGS. 9 and 10 show improvement for an example clock path (of moderate length) having a depth of between five and 20 cells. FIGS. 11 and 12 show improvement for an example (relatively long) clock path having a depth of between 50 and 150 cells. Slack improvement may be as high as 50 ps, or 4-5% of a clock period. These are dramatic differences in the context of modern IC design and performance.

Those skilled in the art to which this application relates will appreciate that other and further additions, deletions, substitutions and modifications may be made to the described embodiments.

1. A system for taking inter-clock correlation into account in on-chip timing derating, comprising:
a storage medium configured to store data and clock path setup and hold early and late derate data; and
an electronic design automation tool configured to employ said data and clock path setup and hold early and late derate data to calculate setup and hold slacks and total derate that take into account a correlation in delay variation between first and second clock paths as a function of depths thereof.

2. The system as recited in claim 1, wherein:
said first clock path is a launch clock path for a data path, and
said second clock path is a capture clock path for said data path.

3. The system as recited in claim 1, wherein said electronic design automation tool is configured to re-calculate a derate for said first and second clock paths based on said correlation and conventionally calculated derate values for said first and second clock paths.

4. The system as recited in claim 3, wherein said electronic design automation tool is configured to calculate setup slack based on said re-calculated derate.

5. The system as recited in claim 4, wherein said electronic design automation tool is configured to calculate a derate for a data path, a derate for said first and second clock paths and a total derate based on said setup slack.

6. The system as recited in claim 1, wherein said electronic design automation tool is configured to calculate a derate for said first and second clock paths based on said correlation.

7. The system as recited in claim 6, wherein said electronic design automation tool is configured to calculate setup slack based on said calculated derate.

8. A method of taking inter-clock correlation into account in on-chip timing derating, comprising:
configuring a storage medium to store data and clock path setup and hold early and late derate data; and
employing said data and clock path setup and hold early and late derate data to calculate setup and hold slacks and total derate that take into account a correlation in delay variation between first and second clock paths as a function of depths thereof.

9. The method as recited in claim 8, wherein:
said first clock path is a launch clock path for a data path, and
said second clock path is a capture clock path for said data path.

10. The method as recited in claim 8, wherein said employing comprises re-calculating a derate for said first and second clock paths based on said correlation and conventionally calculated derate values for said first and second clock paths.

11. The method as recited in claim 10, wherein said employing comprises calculating setup slack based on said re-calculated derate.

12. The method as recited in claim 11, wherein said employing comprises calculating a derate for a data path, a derate for said first and second clock paths and a total derate based on said setup slack.

13. The method as recited in claim 8, wherein said employing comprises calculating a derate for said first and second clock paths based on said correlation.

14. The method as recited in claim 1, wherein said employing comprises calculating setup slack based on said calculated derate.

15. A non-transitory computer-readable storage medium containing program instructions for taking inter-clock correlation into account in on-chip timing derating, execution of said program instructions by one or more processors of a computer system causing said one or more processors to:
configure a storage medium to store data and clock path setup and hold early and late derate data; and
employ said data and clock path setup and hold early and late derate data to calculate setup and hold slacks and total derate that take into account a correlation in delay variation between first and second clock paths as a function of depths thereof.

16. The computer-readable storage medium as recited in claim 15, wherein:
said first clock path is a launch clock path for a data path, and
said second clock path is a capture clock path for said data path.

17. The computer-readable storage medium as recited in claim 15, wherein said execution of said program instructions by said one or more processors of a computer system further causes said one or more processors to re-calculate a derate for said first and second clock paths based on said correlation and conventionally calculated derate values for said first and second clock paths.

18. The computer-readable storage medium as recited in claim 17 wherein said execution of said program instructions by said one or more processors of a computer system further causes said one or more processors to calculate setup slack based on said re-calculated derate.

19. The computer-readable storage medium as recited in claim 18, wherein said execution of said program instructions by said one or more processors of a computer system further causes said one or more processors to calculate a derate for a data path, a derate for said first and second clock paths and a total derate based on said setup slack.

20. The computer-readable storage medium as recited in claim 15, wherein said execution of said program instructions by said one or more processors of a computer system further causes said one or more processors to calculate a derate for said first and second clock paths based on said correlation.

21. The computer-readable storage medium as recited in claim 20, wherein said execution of said program instructions by said one or more processors of a computer system further causes said one or more processors to calculate setup slack based on said calculated derate.
